(19) United States
(12) Patent Application Publication
(10) Pub. No.: US 2015/0213697 A1
(43) Pub. Date: Jul. 30, 2015

(54) MULTI-MODE DETECTION

(71) Applicant: Xtralis Technologies Ltd, Nassau, NP (BS)

(72) Inventors: Ron Knox, Victoria (AU); Matthew Naylor, Worthing Sussex (GB); Kemal Ajay, Mount Waverley (AU); Rajiv Singh, Glen Waverley (AU)

(73) Assignee: Xtralis Technologies Ltd, Nassau, NP (BS)

(21) Appl. No.: 14/405,719

(22) PCT Filed: Jun. 7, 2013
(86) PCT No.: PCT/AU2013/000611

§ 371 Date: Dec. 4, 2014

(30) Foreign Application Priority Data
Jun. 8, 2012 (AU) 2012902414

(51) Int. Cl. G08B 17/10; G06T 7/40

(52) U.S. Cl. CPC G08B 17/10; G06T 7/40; G06T 2207/10016; G06T 2207/30232

(57) ABSTRACT

The invention relates to a particle detector, systems, and methods for detecting the presence of particles in a volume of air, most particularly it relates to detection systems and methods that use multiple modes of detection to detect the presence of particles. Preferably the particles being detected are particles that indicate an actual or incipient fire, or pyrolysis, such as smoke.

### FIELD OF THE INVENTION

The invention relates to a particle detector for detecting the presence of particles in a volume of air, most particularly it relates to detection systems that use multiple modes of detection to detect the presence of particles. Preferably the particles being detected are particles that indicate an actual or incipient fire, or pyrolysis, such as smoke.

### BACKGROUND OF THE INVENTION

Smoke and fire detection systems are core components of ensuring life and property safety in many homes, businesses, infrastructure installations and institutions.

Such systems place detectors in a location that allows the detector to detect the presence of particles in a volume of air in the location being monitored.

A range of different types of particle detectors can be used to detect smoke in an air sample drawn (either passively, e.g. by diffusion of particles of interest into an analysis chamber; actively by application of suction, as is performed in aspirating smoke detectors) from the volume being monitored including: ionisation detectors, which detect the presence of particles within an ionisation chamber; and optical smoke detectors, which include nephelometers, and obscuration monitors, which detect the presence of particles in an air sample within an analysis chamber by measuring the obscuration with a beam of light passing through the air sample.

In addition to these types of detectors, which operate on air samples drawn from the area being monitored, more recently attempts have been made to perform open area particle detection directly in the volume of air in the region being monitored for smoke or fire. For example, video smoke detection uses video analytic techniques to determine whether smoke or fire is present in a scene being imaged by a camera. Beam detectors are also known. This type of detector is essentially an obscuration detector which operates without a chamber, but instead emits a beam of light across the volume of air being monitored to directly identify smoke in the volume.

Xtralis Pty Ltd has also developed further techniques including active video smoke detection, which operates similarly to a nephelometer, but instead of operating on an air sample within a particle detection chamber, active video smoke detection involves the transmission of a beam of radiation into the volume being monitored and detects scattered light from the beam in a sequence of video images of the volume. Xtralis Pty Ltd have also developed enhanced beam detector techniques which use multiple wavelengths of radiation and video image capture to detect particles obscuring the beams of radiation. Detection of smoke particles involves using video images of the beam to perform a comparison of obscuration at the multiple wavelengths.

Despite all of these different technologies and techniques there are still competing interests when attempting to detect particles and, in particular, smoke. For instance, on the one hand it is desirable to detect particles early in order to enable preventative action, or at least attempt to take action before a fire becomes uncontrollable. In order to do this, high sensitivity equipment is desirable. On the other hand, overly sensitive equipment can lead to a prevalence of false alarms which are distracting and costly to deal with. Moreover, it would be desirable for the exact location of fire to be determined using a smoke detection system. This can be difficult to achieve using point (or spot) detectors as it would be necessary to place a large number of point detectors in the area being monitored, which would be impractically expensive. Video smoke detection systems overcome some of these difficulties, but are less reliable in detecting smoke, and more prone to false alarms caused by interfering objects within the volume being monitored.

Because of the serious consequences of failure or malfunction of particle detectors these systems are also typically governed by strict standards and regulations for their use. This means that the options available to a premises owner for monitoring for smoke and fire are typically limited to systems that meet these legislatively required standards.

Accordingly, there is a need for more flexible systems for detecting smoke and other particles and also the need to address some of the trade-offs discussed above in a more favourable way for their end user.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In a first aspect of the invention there is provided a particle detection device for detecting particles in a volume of air, the device including: an internal detector for detecting the presence of particles in an air sample representative of the volume of air; at least one radiation emitter for projecting a radiation beam through at least a part of the volume of air to interact with particles in the volume to thereby enable in the presence of particles volume of air to be detected. Preferably the particles are smoke particles.

Preferably, the particle detection device includes at least one sensor, positioned to sense radiation from at least a portion of the radiation beam. More preferably, the sensor is a camera positioned to capture images of at least a portion of the radiation beam.

In a second aspect of the invention, there is provided a particle detection device for detecting particles in a volume of air, the device including: an internal detector for detecting the presence of particles in an air sample representative of the volume of air; at least one sensor, the sensor positioned to obtain information from at least a portion of a radiation beam passing through the volume of air and to analyse the obtained interaction to indicate the presence, of particles in the volume of air. Preferably the sensor is a camera positioned to capture images of at least a portion of the radiation beam.

In a third aspect of the present invention there is provided a particle detection device for detecting particles in a volume of air, the device including: an internal detector for detecting the presence of particles in an air sample representative of the volume of air; at least one camera configured to capture a series of images of the volume of air and to enable detection of particles in the volume of air. Preferably the apparatus includes a processor system to analyse the series of images to detect the presence of particles in the volume of air. In one form the processor can apply video analysis techniques to detect that either or both a plume of smoke or flames are present in the series of images. Alternatively or additionally the processor can detect the presence of radiation emitted into the volume, in the series of images and thereby detect particles interacting with the emitted radiation.

Each of the particle detection devices described above may be used as a component of a multi-mode particle detection system. Furthermore, there is provided the use of a multi-mode particle detection device as described above for detecting particles.

In a fourth aspect of the invention, there is provided a multi-mode particle detection system for detecting particles in a volume of air, the system including: at least one particle detection device, the device including: an internal detector for detecting the presence of particles in an air sample representative of the volume of air, and at least one radiation emitter for projecting a radiation beam through at least a part of the volume of air; the system further including at least one sensor, the sensor positioned to obtain information from at least a portion of the radiation beam, and analysis means, to analyse the information from at least the portion of the radiation beam, to detect particles in the volume of air. In one embodiment the at least one sensor may be integrated as a component of the particle detection device, or alternatively the at least one sensor may be separate from the particle detection device.

In a fifth aspect of the invention, there is provided a multi-mode particle detection system for detecting particles in a volume of air, the system including: at least one particle detection device, the device including: an internal detector for detecting the presence of particles in an air sample representative of the volume of air, at least one sensor, the sensor positioned to obtain information from at least a portion of the radiation beam; the system further including: at least one radiation emitter for projecting a radiation beam through at least a part of the volume of air, and analysis means, to analyse the information from at least the portion of the radiation beam, to detect particles in the volume of air.

In a sixth aspect of the invention, there is provided a multi-mode particle detection system for detecting particles in a volume of air, the system including: apparatus defining an internal detection mode, including a particle detection device with an internal detector for detecting the presence of particles in the volume of air; and apparatus defining an external detection mode, including: at least one radiation emitter for projecting a radiation beam through at least a part of the volume of air, at least one sensor, the sensor positioned to obtain information from at least a portion of the radiation beam, and analysis means, to analyse the information from at least the portion of the radiation beam, to detect particles in the volume of air; wherein the particle detection apparatus of the internal detection mode, and either or both of the at least one radiation emitter or the at least one sensor of the external detection mode form a unitary device.

In an embodiment of the invention, any of the above described systems may further include a reflector as a component of the system for reflecting or redirecting the radiation beam.

Preferably the at least one particle detection device and the reflector are separate devices, although the reflector may be integrated into a particle detection device.

Preferably the at least one sensor is a camera positioned to capture images of at least a portion of the radiation beam.

Preferably the camera is a separate device from the particle detection device, although the camera may be integrated into a particle detection device.

Preferably the analysis means determines whether particles are present in the volume of air using scattered radiation captured in the images. This scattered radiation may be either forward scattered, or back scattered radiation. In another aspect of the invention, there is provided the installation of a multi-mode particle detection system as previously described.

In another aspect of the invention, there is provided the use of a multi-mode particle detection system as previously described, to detect particles.

In a seventh aspect of the invention, there is provided a method of detecting particles in a volume of air using a multi-mode particle detection system, the method including: analysing an air sample representing a portion of the volume of air to detect particles according to a first detection mode, using a particle detection device with an internal particle detector; and in the event that at least one particle detection criterion is met in the first detection mode, activating a second detection mode including: projecting a radiation beam through at least a part of the volume of air, obtaining information from at least a part of the radiation beam, analysing the information from at least a part of the radiation beam to detect particles in the volume of air; wherein the step at least one of: (i) projecting the radiation beam, or (ii) obtaining information about at least a part of the radiation beam, are conducted using the particle detection device.

In a eighth aspect of the invention, there is provided a method of detecting particles in a volume of air using a multi-mode particle detection system, the method including: detecting particles according to a first detection mode, including: projecting a radiation beam through at least a part of the volume of air, obtaining information from at least a part of the radiation beam, analysing the information from at least a part of the radiation beam to detect particles in the volume of air; and in the event that at least one particle detection criterion is met in the first detection mode, activating a second detection mode including analysing an air sample representing a portion of the volume of air to detect particles using a particle detection device with an internal particle detector; wherein the step at least one of: (i) projecting the radiation beam, or (ii) obtaining information about at least a part of the radiation beam, are conducted using the particle detection device.

Preferably the step of obtaining information about at least a part of the radiation beam includes capturing images of at least a portion of the radiation beam.

Preferably the step of analysing the information includes determining whether particles are in the volume of air using scattered radiation captured in the images.

Preferably the step of projecting the radiation beam includes projecting the radiation beam onto a reflector.

In one aspect the methods described previously, further include a third detection mode, the third detection mode using video analysis. Preferably the video analysis is performed to verify the presence of particles. In a most preferred method the verification is signalled to an operator.

In one embodiment there is provided a detection system including a smoke and/or fire detection system and a video verification system. The smoke and/or fire detection system is configured to detect the presence of smoke and or fire in a volume being monitored.

The video verification system is arranged to capture images of at least part of the volume being monitored, and analyse the images to determine the appearance of smoke and/or fire in the images. In the event that the appearance of smoke and/or fire in the images is determined, and that smoke and/or fire is detected by the smoke and/or fire detection system an alert output is produced. Preferably the detection system is configured to provide an output that the presence of smoke and/or fire detected by the smoke and/or fire detection system is verified.

The smoke and or fire detection system may be a conventional smoke and/or fire detection system or a multi-mode detection system as described elsewhere herein.

In another aspect of the present invention there is provided an alert system including: at least one first input to receive a signal indicating a sensed condition from a sensor system that indicates the presence of smoke and/or fire; at least one second input to receive a signal derived from a video capture system; the alert system being configured to indicate a first alert condition based on the at least one first input; and to indicate a second alert condition in the event that the sensed condition is verified by the signal derived from the video capture system.

The alert system can receive a series of images captured by the video capture system on a second input and process the images to determine whether smoke and/or fire is present in images captured by the video capture system.

Alternatively the alert system can receive a signal from the video capture system indicating that smoke and/or fire is present in images captured by the video capture system. In this case, video images may additionally be received on a second input. The video images may include a visual indication of the location, volume, shape or other parameter of the smoke and/or fire that is determined to be present in the images.

In another aspect, the present invention provides an interface for an alert system including an interface portion for indicating a plurality of alert conditions, including alert conditions relating to fire and/or smoke detection, and an interface element configured to indicate that an alert condition relating to fire and/or smoke detection has been verified. Preferably the interface element is configured to indicate that an alert condition relating to fire and/or smoke detection has been verified on the basis of one or more images of a volume being monitored for fire or smoke.

Most preferably the verification is automatically performed by analysing a series of images to determine that an image of smoke or fire is present in the captured images.

The interface element can be, for example, an icon, indicia, colour selection, alphanumerical indicator, indicated status level, variation in display style, order, or any other interface element, or change or modulation of an other interface element that conveys that the alert condition has been verified.

The interface can additionally include a portion to display at least part of an image captured by the video capture system, to enable visual confirmation of the alert condition by an operator. In this case, images displayed may include a visual indication of the location, volume, shape or other parameter of the smoke and/or fire that is determined to be present in the images.

In another aspect there is provided a method including: receiving smoke and/or fire detection data corresponding to a plurality of sensors arranged in respective locations; receiving at least one image of the respective locations; providing an interface for viewing the display of least one image of the respective locations according to a priority level determined on the basis of at least one of: received smoke and/or fire detection data; an analysis of at least one image of the respective locations; location parameter data describing one or more characteristics pertaining to the locations.

The method can include generating a one or more alerts corresponding received smoke and/or fire detection data.

The received smoke and/or fire detection data could include parameters such as the volume of the detected smoke and/or fire, and/or the rate of increase of the volume of smoke and/or fire.

The method can include prioritising display of the one or more alerts corresponding received smoke and/or fire detection data on the basis of the determined priority level.

In another aspect, the present invention provides an interface for an alert system including an interface portion for indicating a plurality of alert conditions, including alert conditions relating to fire and/or smoke detection, and an interface element configured to indicate a priority of an alert condition relating to fire and/or smoke detection.

Preferably the priority is determined at least partly on the basis of whether the alert has been verified. Most preferably the priority is based on analysis of a plurality of images of a volume being monitored.

The interface element can be configured to indicate that an alert condition relating to fire and/or smoke detection has been verified on the basis of one or more images of a volume being monitored for fire or smoke.

The interface can additionally include a portion to display at least part of an image captured by the video capture system, to enable visual confirmation of the alert condition by an operator. In this case, images displayed may include a visual indication of the location, volume, shape or other parameter of the smoke and/or fire that is determined to be present in the images.

In some embodiments the priority of an alert condition relating to fire and/or smoke detection can be determined at least in part on the basis of an automated measure of any one or more of: size, intensity, density, growth; for any one of: fire, smoke cloud or particle-cloud.

The method can include, for a given alert, indicating an investigation priority on the basis of, any one or more of: received smoke and/or fire detection data; an analysis of at least one image of the respective locations; location parameter data describing one or more characteristics pertaining to the locations.

Most preferably the step of indicating an investigation priority includes ordering a sequence in which images of a series of locations are to be displayed; the investigation priority being determined to increase the likelihood that an origin of the cause of the alert will be discovered, by visual inspection of images of the locations.

The location parameter data could describe characteristics pertaining to the location, such as; a location's actual position, position relative to other locations, construction of rooms or other things in the location, wind or airflow speed, direction, patterns; location usage pattern, usage type; HVAC system parameters, to name a few.

In another aspect of the present invention there is provided an apparatus comprising: a delivery system for delivering a test substance to a particle detector arranged to protect a location; an activation means to activate the delivery system to deliver the test substance;

a indicator signalling the activation of the delivery system, such that the activation can be automatically detected by an image capture system arranged to capture images of the location.

The apparatus can further includes an interface enabling data regarding the activation to be entered into the apparatus for storage or transmission thereby. The delivery system can comprise at least one of: a test substance generator; a duct for delivering a test substance to a the particle detector from a test substance generator; a fan, pump or the like to move the test substance through the apparatus to the particle detector. The indicator preferably comprises one or more radiation emitters configured to emit radiation for capture in an image. The apparatus can include a synchronisation port, to enable data transfer to and/or from the apparatus to an external device, such as the particle detection system or video capture system.

In another aspect the present invention provides a method for correlating an address in a particle detection system, said address corresponding to a physical location, with a location being monitored in a video capture system that monitors a plurality of locations; the method comprising; causing the detection of particles in the particle detection system at the address;

indicating visually a physical location corresponding to the address; identifying the visual indication of the physical location in at least one image captured by the video capture system;

correlating address with a location of the plurality of locations monitored by the video capture system.

The method preferably includes correlating the address with one or more of: a camera that captured the at least one image in which the visual indication was identified; One or more of a pan, tilt or zoom parameter of a camera that captured the at least one image in which the visual indication was identified.

The method can include providing the correlation data to the video capture system to enable selective capture, storage or display of images relating to corresponding to an address in the particle detection system in the event that particles are detected by the particle detection system at the address. Described herein this allows video verification of the particle detection event.

The step of indicating visually a physical location corresponding to the address can include, emitting radiation that can be captured and identified in an image captured by the video capture system. This can includes selectively activating a radiation source in a detectable pattern. For example on-off modulating a light source.

The step of causing the detection of particles in the particle detection system preferably includes emitting particles at, or near, the physical location so as to be detected by the particle detection system at the address.

The step of causing the detection of particles in the particle detection system at the address; and indicating visually a physical location corresponding to the address are preferably performed simultaneously to enable temporal correlation between images captured by the video capture system with a particle detection event in the particle detection system.

Most preferably the method is performed using an apparatus of the previous aspect of the present invention.

In another aspect, there is provided a capacity system programmed to perform at least part of any one of the methods described herein.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 provides an illustrative example of a multi-mode particle detection system including device 1 and a separate sensor unit.

FIG. 2 provides an illustrative example of a multi-mode particle detection system including device 2 and a separate radiation emitting unit.

FIG. 3 provides an illustrative example of a multi-mode particle detection system including device 1 and device 2.

FIG. 4 provides an illustrative example of a multi-mode particle detection system including device 3 and a reflector.

FIG. 5 provides an illustrative example a particle detection system including: three multi-mode detectors (based on devices 1, 2 and 3) and a separate radiation emitting unit.

FIG. 6 provides an illustrative example of a multi-mode particle detection system including device 1 and a separate sensor unit.

FIG. 7 provides an illustrative example of a multi-mode particle detection system including device 2 and a separate radiation emitting unit.

FIGS. 8A, 8B and 8C are schematic block diagrams illustrating respectively type 1, type 2 and type 3 detection devices usable in various embodiments of the present invention.

FIG. 9 is a diagram illustrating a map of a building being monitored using a smoke detection system with video verification.

FIGS. 10 and 11 illustrate exemplary interfaces for an alert system implementing automatic verification according to an embodiment of an invention described herein;

FIG. 12 is a schematic diagram of an apparatus used for commissioning and/or testing of a system of the type illustrated in FIG. 9.

### DETAILED DESCRIPTION OF THE EMBODIMENTS

The invention relates to particle detection systems. The system in the illustrated embodiments includes multiple detection modes for determining the presence of particles in a volume of air of interest (i.e. a volume of air). Two of the detection modes can be broadly described as an internal particle detecting mode and an external particle detecting mode. The order that these modes are operated in can vary depending on the specific operating parameters of the system. That is, the first mode is an internal detecting mode, and the second mode is an external detecting mode; or the first mode is an external detecting mode, and the second mode is an internal detecting mode. Additional detection modes may be added (for example a third detecting mode) if required.

The internal detection mode operates through use of a device with an internal particle detection system. The internal detection mode is provided with, or obtains a sample of air representing the volume of air of interest. The sample can be obtained through passive means, such as by relying of diffusion of particles through the air, or by convection. Alternatively, the sample can be obtained by active means, wherein the device exerts a suction pressure to draw air into the internal detector. Once obtained, this air sample is then analysed by the internal particle detector. The internal particle detector can be an optical particle detector like a nephelometer or obscuration detector; or be an ionisation detector; other detection mechanisms may also be used.

In one embodiment the internal detection mode is able to detect particle concentration. There may different alarm levels associated with various particle concentrations. For example, a range of particle concentration thresholds bands may be set covering a range of different particle concentrations. Each of the particle concentration thresholds having a minimum particle concentration value which triggers an alarm associated with that threshold, and a maximum particle concentration which corresponds with the minimum particle concentration of the next particle concentration threshold. Reaching this maximum concentration value (i.e. the minimum concentration value of the next concentration threshold) raises the alarm level. In this manner, an operator can determine the urgency and/or importance of an alarm.

The external detection mode operates through use of a detection system that monitors the volume of air directly using optical systems, rather than drawing a sample from it. There are a number of suitable optical means for monitoring the volume of air, such as through use of a conventional obscuration—type beam detector, an active video smoke detector, or an open-area smoke imaging detector. Many of these mechanisms have been described in the earlier applications by Xtralis Technologies Ltd; see for example WO 2004/102498, WO 2006/050670 WO 2009/062256, WO 2009/149498, and WO 2010/124347, each of which is incorporated in their entirety herein by reference. This second mode of detection involves the monitoring of a radiation beam and detecting particles as a result of a change in the state or the properties of the beam.

Thus the particle detector of this particle detection system broadly comprises a number of components including at least: (i) a particle detector with an internal particle detection system, (ii) a radiation emitter for projecting a radiation beam through the volume of air, (iii) a sensor for monitoring at least a portion of the radiation beam, and (iv) analysis means for interpreting the information obtained by the sensor and determining whether particles are present in the volume of air.

The radiation beam could include any wavelength of electromagnetic radiation, including radiation falling in the visible spectrum, and non-visible parts of the spectrum, such as: infra-red, ultraviolet, or longer or shorter wavelength bands. In certain embodiments, the radiation used will be confined to a narrow band, whereas in other embodiments the radiation will cover a wide bandwidth. The beam can be of any geometry, including: collimated, planar, or divergent. The radiation beam may be produced by a laser, laser diode, LED, or other sufficiently intense radiation source.

In one embodiment, the internal detection mode uses an aspirated particle detector as the internal particle detection system. This internal detection mode can be paired with a variety of external detection modes, some of which have been described previously. A non-limiting disclosure of potential arrangements is provided below.

In one embodiment, the external detection mode uses a beam of radiation, such as a laser, to monitor a region, such as a room. A sensor, which in this embodiment is a camera, is used to capture images of part of the room, including the path of the laser beam. If particles are present in the path of the laser beam, light from the laser beam is scattered. A processor then determines whether particles are present on the basis of whether scattered light is captured by the camera.

In another embodiment, the external detection mode uses a beam of radiation, such as a laser, to monitor a region, such as a room. A sensor, which in this embodiment is a photodiode, is used to measure the intensity of the laser beam. Particles in the path of the laser beam reduce the intensity of the laser beam, causing a lower intensity to be measured by the photodiode. A processor then determines whether particles are present on the basis of whether the intensity of the laser beam is reduced.

In a further embodiment, the external detection mode uses at least two beams of emitted radiation to monitor a region, such as a room. In this embodiment, the beams have different wavelengths, for example one beam may be of ultra-violet radiation, and the other may be of infra-red radiation. A sensor, which in this case is an imaging chip with multiple pixels (i.e. as used in a digital camera) is used to monitor the intensity of each of the beams. A processor then determines whether particles are present on the basis of a change in an intensity of either of the beams.

The arrangement of these components within the system can vary. It will be understood that the particle detector may include a combination of some, or all of the above listed components. A number of different embodiments, encompassing possible arrangements of the multi-mode particle detector device are described below. These arrangements are intended to illustrate possible arrangements, and are not intended to limit the scope of possible arrangements.

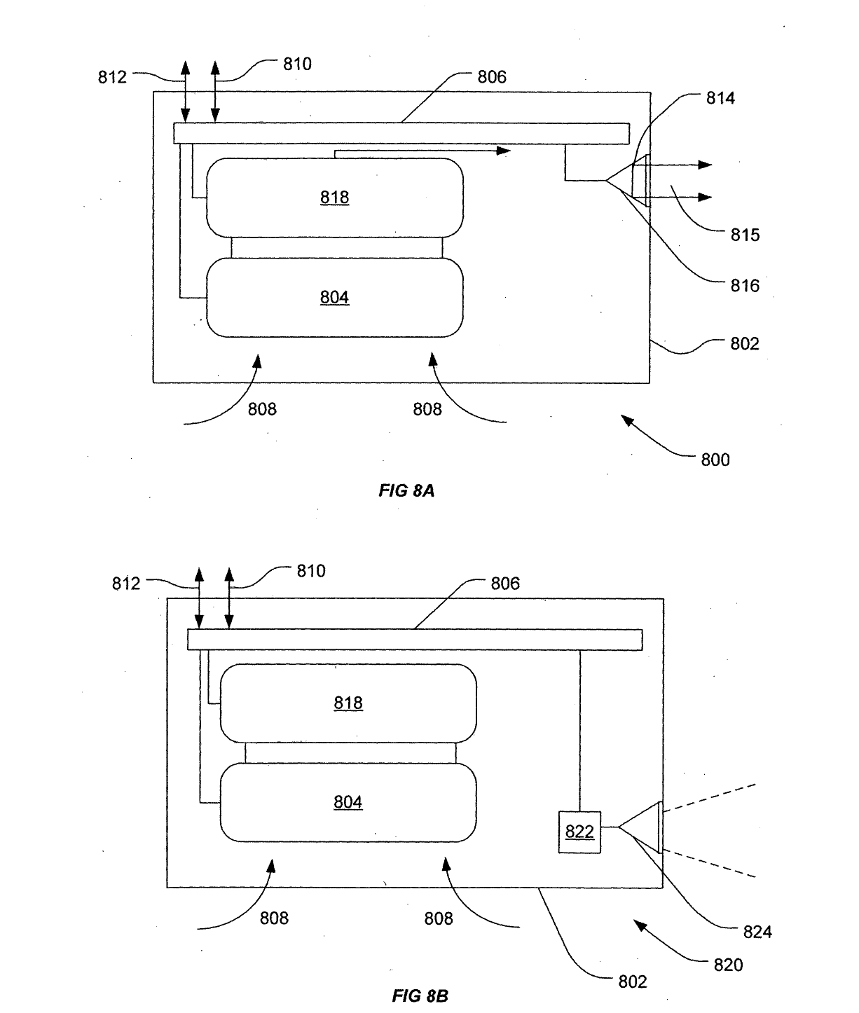

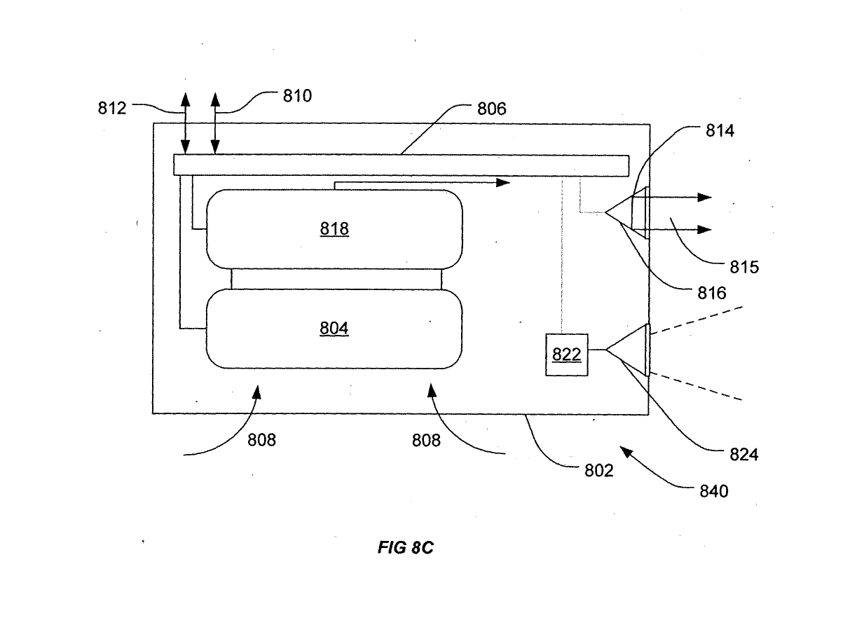

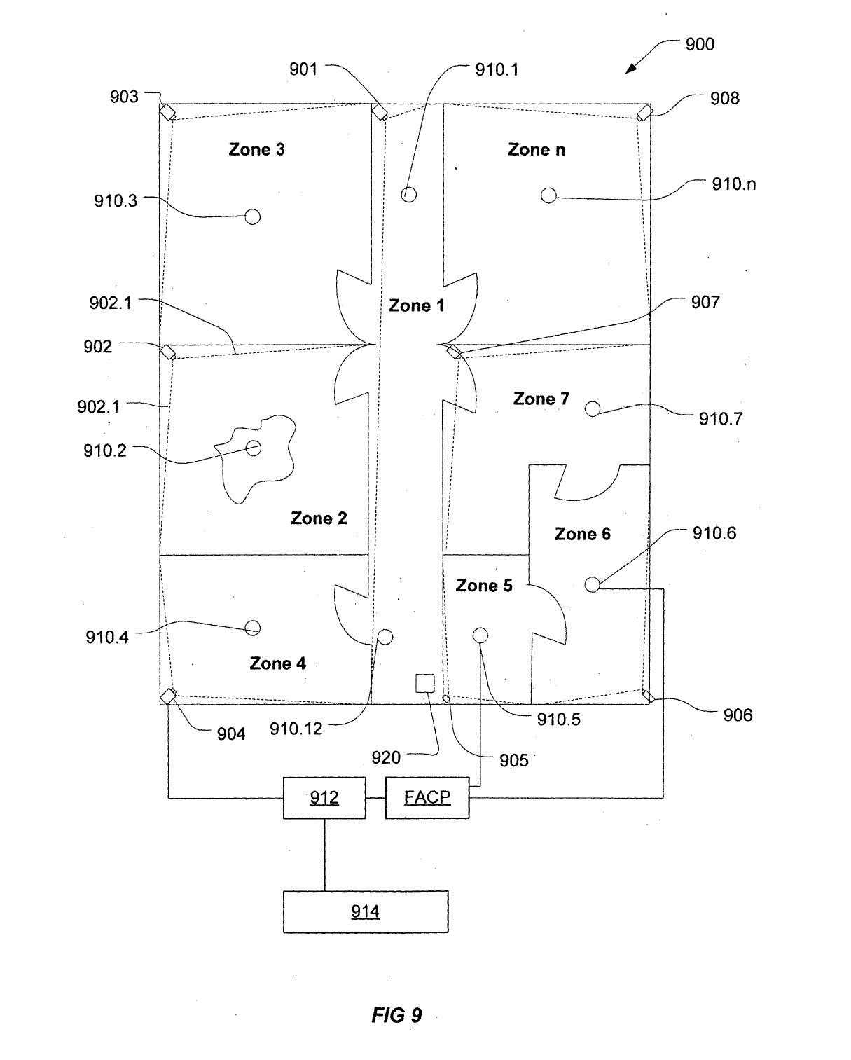

In one embodiment, there is provided a particle detection device that includes: (i) a particle detector with an internal particle detection system, and (ii) a radiation emitter for projecting a radiation beam through the volume of air. This device will be referred to as a type-1 device throughout the specification. FIG. 8A illustrates a type-1 device 800. The device 800 includes a housing 802, containing a particle detection chamber 804. The detection chamber 804 can use any type of mechanism to detect the presence of particles including but not limited to an optical particle detector like a nephelometer or obscuration detector; or ionisation detector.

An air sample is introduced to the detection chamber 804 through an inlet path 808 into the housing, e.g. via a duct or directly through apertures through the walls of the housing 802. The chamber 804 is connected to a control system 806 that includes suitable electronic systems to process an output signal of the detection chamber 804 and either apply suitable alarm logic to the output signal to determine the presence of particles or pass the processed output signal to an associated device (e.g. a fire panel or central controller) to process the detection chamber's output signal. The control system 806 is thus provided with a data communications interface 810 via which data can be exchanged with external devices. A user interface (not shown) could also be provided. The device 800 also includes a light source 814 and (optional) optical system 816, for emitting a beam of light. The beam of radiation 815 is emitted such that it traverses the volume being monitored, to enable an open area particle detection process to be performed as described herein. Power is delivered to the device 800 via a power connection 812. In this example an optional aspirating device 818 is provided to draw an air sample into the detection chamber 804 from the volume being monitored.

The control system 806 is configured to activate the light source 814 either upon occurrence of a predefined event, e.g. receipt of a signal from an external device, or detection of particles by the internal chamber etc. or according to some other scheme, e.g. periodically, randomly, upon occurrence of some other related event.

In another, there is provided a particle detection device that includes: (i) a particle detector with an internal particle detection system, and (ii) a sensor for monitoring at least a portion of the emitted radiation beam. This device will be referred to as a type-2 device throughout the specification.

FIG. 8B illustrates a type-2 device 820. The device 820 includes is similar to the device 800 of FIG. 8A, and common parts are numbered with the same reference numerals. The primary difference between the type-1 and type-2 devices is that, instead of a light source, the Type-2 device 820 includes a sensor 822 and (optional) associated optical system 824. The light sensor 822 is arranged to radiation from at least part of the volume being monitored, such that the presence of smoke and or fire can be detected or verified. In a preferred form the sensor is a video camera or the like. The device 820 can be arranged such that the camera 822 can capture images of the region to enable video smoke and/or flame detection to be performed, or such that it can be radiation sensor forming part of a beam detector, active video smoke detection or other open area optical smoke detection system.

The control system 806 is configured to activate the camera periodically as described above in relation to the type-1 device or continuously. The advantage of continuous operation is that the sensor (if it is a camera) could additionally operate as a security camera for the volume being monitored, moreover it can aid in performing video analytics processes in a manner that will be described in more detail below.

In a further embodiment there is provided a particle detection device that includes: (i) a particle detector with an internal particle detection system, (ii) a radiation emitter for projecting a radiation beam through the volume of air, and (iii) a sensor for monitoring at least a portion of the emitted radiation beam. This device will be referred to as a type-3 device throughout the specification.

FIG. 8C illustrates a type-3 device 840. The device 840 includes is similar to the devices 800 and 820 of FIGS. 8A and 8B, and common parts are numbered with the same reference numerals. However, the type 3 device 840, includes both a transmitter 814 and sensor 822. Because the device 820 has both a transmitter 814 and a received 822, it can operated as a stand alone beam detector with the use of a reflector or AVSD detector either using a reflector or without a reflector in a backscatter geometry. The device 802 could also cooperate with other devices, e.g. stand alone light sources, cameras or sensors, or other type 1, 2 or 3 devices to form multiple external detectors. Additionally, each of the above described embodiments may include the analysis means for interpreting the information obtained by the sensor from the radiation beam as part of the particle detector, or may exclude the analysis means from the particle detector.

The particle detection system may include a single device, or multiple devices, wherein various non-limiting embodiments of the particle detection device have been described above as type-1, type-2, and type-3 devices. The particle detection system, in addition to including at least one particle detection device, may also include additional particle detectors, radiation emitters, and/or sensors. The particle detection system must include sufficient components arranged in a manner such that at least an internal mode and an external mode of particle detection are possible.

It is desirable in some instances to include in the particle detection system multiple radiation emitting components, whether as a part of the particle detection device or as components which are separate from the particle detection device. Similarly, it is desirable is some instances to include multiple sensors for monitoring a radiation beam over multiple locations, or for monitoring multiple radiation beams (for example, if multiple emitters are used). The use of additional or supplementary components may be to provide back up, or to assist in either covering additional regions, or a larger volume of air than possible with only with a single emitter or sensor.

In some embodiments, the particle detection system may additionally include a reflector. The reflector may be included as a component in any of the type-1, type-2, or type-3 devices, or as a component of a separate device. The reflector may have only one reflective surface, or a plurality of reflective surfaces. The reflector may for example be a corner reflector adapted to reflect a beam of light at a substantially fixed angle to an incident beam. Alternatively, the reflector may be steerable to change the path of the incident or reflected beam. The term “radiation beam” as recited throughout is intended to encompass the entire beam from emission, including any incident and reflected portions.

The invention also relates to a method of detecting particles in a volume of air using a multi-mode particle detection system. The method includes detecting particles according to a first detection mode and then activating the second detection mode in order to detect particles according to the second detection mode. Thus, in the event that at least one of the particle detection criteria is met in the first detection mode, the second detection mode is then activated.

As described previously, the internal detection mode detects particles through use of a device having an internal detection particle detector (as described previously). The external detection mode detects particles through use of a detection system that monitors the volume of air optically. When the external detection mode is active, at least one radiation emitter projects a radiation beam through at least part of the volume of air. A sensor then obtains information from at least a part of the radiation beam. An analyser analyses the information to detect the presence of particles in the volume of air.

In this method, the step at least one of: (i) projecting the radiation beam, or (ii) obtaining information about at least a part of the radiation beam, is conducted using the particle detection device. That is, in addition to detecting particles according to an internal detection mode, the particle detection device also detects particles according to an external detection mode by either: (i) projecting the radiation beam, or (ii) obtaining information about at least a part of the radiation beam.

The first detection mode is the active detection mode, and may either be constantly running, or run periodically according to a schedule. The first detection mode may either be the internal detection mechanism, or the external detection mechanism. When the first detection mode is the internal detection mechanism, the second detection mode is the external detection mechanism. Conversely, when the first detection mode is the external detection mechanism, the second detection mode is the internal detection mechanism.

In one embodiment, the first detection mode may be a non-standards approved particle detection mode, and/or is able to detect particles at a distance from the particle sensor (i.e. uses an external particle detection mechanism). In this case, the first detection mode provides a first alarm state on detection of particles. This first alarm state is a pre-alarm that triggers the second mode of particle detection; an indication of the activation of the first alarm state may also be communicated electronically (e.g. to a fire alarm control panel, or monitoring system), to indicate that the first detection mode has detected particles. The second mode of particle detection may be a standards approved particle detection mode, and/or detect particles using an internal particle detection mechanism. If the second detection mode detects particles, a second alarm state is provided. This second alarm state positively indicates the detection of particles, may result in an operator being provided with a higher level alarm indicating that particles have been detected and thus verifying the first alarm state, or increasing the importance level of the alarm state, or may result in an alarm being triggered.

In another aspect, the first detection mode of particle detection may be an approved particle detection mode, provide high sensitivity particle detection, and/or detects particles using an internal particle detection mechanism. If the first detection mode detects particles, a first alarm state is provided. As this mode is an approved mode of particle detection, the first alarm state positively indicates the detection of particles and may result in an operator being provided with a high level alarm indicating that particles have been detected, or may result in an alarm being triggered. The first alarm state also triggers the second mode of particle detection which provides video verification or active video detection of the particles. This second particle detection mode provides positional information regarding the position of the particles in the volume of air.

In one embodiment, the first detection mode is the external detection mode and the second detection mode is an internal detection mode. In this embodiment, the first detection mode uses an external particle detection mechanism, such as an active video detection system; the second detection mode uses an internal particle detection system, such as a point detector or an aspirating particle detector having an internal nephelometer type arrangement.

When active, the method of the first detection mode includes: projecting a radiation beam through at least a part of the volume of air that is being monitored; obtaining information from at least a part of the radiation beam; and analysing the information from at least a part of the radiation beam to detect particles in the volume of air. In the event that particles are detected, a first alarm is triggered. The first alarm may illuminate a light on a switch board to indicate that particles have been detected and/or the first alarm may inform an operator that a particle detection event has occurred. The triggering of the first alarm activates the second mode of particle detection.

When active, the second mode of particle detection includes analysing an air sample representing a portion of the volume of air to detect particles, using a particle detection device with an internal particle detector; and in the event that at least one particle detection criterion is met activating a second alarm.

In this method, at least one of: (i) projecting the radiation beam, or (ii) obtaining information about at least a part of the radiation beam, is conducted using the particle detection device.

Additional detection modes may be added as required. Depending on the system, the second alarm state may also trigger a third particle detection mode. The third particle detection mode may be another external particle detection method, e.g. to provide positional information regarding where the particles were detected. This information may be inferred from a radiation beam as previously discussed, or may be a video verification mode. In this case, the first and third detection modes may share the same physical components of the detection system, such as the camera.

In an alternative method of operating the system of this embodiment, the first particle detection means (being an external particle detection means) may be used to modify the sensitivity of the second particle detection means. The sensitivity can either be increased or decreased depending on the situation. For example, in the event that the first detecting mode detects the presence of particles it can output a signal that causes the second particle detection means to enter a high sensitivity mode to achieve the earliest possible confirmation of particles. Alternatively, in separate method of operation, both the first and second detection modes are operating simultaneously. On the detection of particles by the first detection mode, the sensitivity of the second detection mode may be increased.

In another embodiment, the first detection mode is the internal detection mode and the second detection mode is the external detection mode. In this embodiment, the first detection mode uses an internal particle detector, such as a point detector or aspirating particle detector having an internal nephelometer type arrangement; the second detection mode uses an external particle detection mechanism, such as an active video detection system.

When active, the first mode of particle detection includes analysing an air sample representing a portion of the volume of air to detect particles, using a particle detection device with an internal particle detector; and in the event that at least one particle detection criterion is met activates a first alarm. The first alarm indicates the positive detection of particles, and so may result in an alarm being triggered, and/or informing an operator that particles have been detected. The first alarm activates the second detection mode.

When active, the method of the second detection mode includes: projecting a radiation beam through at least a part of the volume of air that is being monitored; obtaining information from at least a part of the radiation beam; and analysing the information from at least a part of the radiation beam to detect particles in the volume of air. The second detection mode is for obtaining positional information regarding the position of the particles in the volume of air. In this method, at least one of: (i) projecting the radiation beam, or (ii) obtaining information about at least a part of the radiation beam, is conducted using the particle detection device.

Additional detection modes may be added as required. Depending on the system, the second alarm state may also trigger a third particle detection mode. In this case, the third detection mode is a video verification mode. In this case, the second and third detection modes may share the same physical components of the detection system, such as the camera.

In yet another embodiment, neither of the first or second detection modes are interfaced with an alarm system, instead both the first and second detection modes are interfaced with a control panel (such as a fire control panel).

The particle detection devices and systems can be operated according to a number of different methods depending on the specific arrangement of the system. A number of different embodiments, encompassing some of the various arrangements of the particle detection system are described in the examples. Again, these examples are intended to illustrate possible arrangements, and are intended in a non-limiting manner.

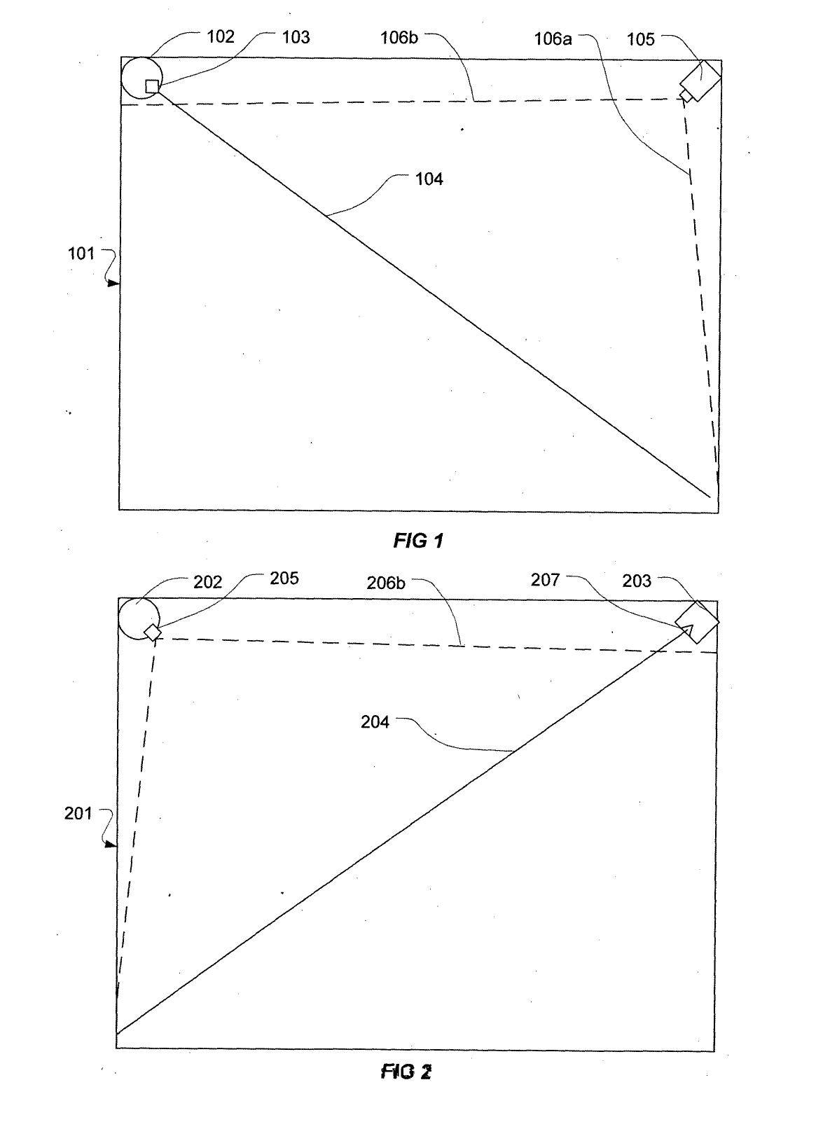

FIG. 1 provides an illustrative example of a multi-mode particle detection system including a type-1 device (102) and a separate sensor unit (105). A room (101) is fitted with a multi-mode particle detection device (102). The device (102) includes an internal particle detector (not shown) and a radiation emitter (103). The radiation emitter can emit a radiation beam (104). The room (101) is also fitted with a sensor (105), which in this particular embodiment is a camera. The camera (105) has a field of view shown by boundary lines (106a) and (106b).

In this example, a first mode of particle detection, using the internal detector of device (102) analyses an air sample representing a portion of the volume of air in the room (101). In the event that at least one of the particle detection criteria is met in the first detection mode a first alarm triggered, and the second detection mode is activated. The first alarm alerts an operator that particles have been detected, and may activate a building alarm. In the second particle detection mode, the device (102) emits a radiation beam (104) from a radiation emitter (103) that is integral with the device (102). A portion of the radiation beam (104) falls within the field of view (106a) and (106b) of the camera (105). The camera (105) captures images of the beam. In this example, these images are analysed for forward and/or back scattered radiation. This scattered radiation provides positional information of the particles in the volume of air. Additionally, a video analytic mode may be activated to provide visual video verification of the presence of particles to an operator. The second detection mode and the video analytic mode may share the same camera.

In an alternative method of operating the system, the first mode of particle detection uses a type-1 device (102) that emits a radiation beam (104) from a radiation emitter (103) that is integral with the device (102). A portion of the radiation beam (104) falls within the field of view (106a) and (106b) of the camera (105). The camera (105) captures images of the beam and analyses the forward and/or backscattered radiation to determine whether particles are present in the volume of air. On detection of particles a first alarm is triggered, and the second detection mode is activated. The first alarm in this case is a low level alarm that indicates particles have been detected. In this second detection mode, the internal detector of device (102) analyses an air sample representing a portion of the volume of air in the room (101). In the event that at least one of the particle detection criteria is met in the second detection mode a second alarm is triggered. This second alarm is higher priority alarm that provides an indication of the presence of particles at a higher level of urgency to an operator. This second level alarm may also trigger a building alarm. Additionally, the second alarm may trigger a third detection mode based on a video analytics, in this mode a camera may be activated to provide visual video verification of the presence of particles to an operator. The first detection mode and the third detection mode may share the same camera.

FIG. 2 provides an illustrative example of a multi-mode particle detection system including a type-2 device (202) and a separate radiation emitting unit (203). A room (201) is fitted with a multi-mode particle detection device (202) and a radiation emitting unit (203). The device (202) includes an internal particle detector (not shown) and a sensor (205), which in this embodiment is a camera. The camera has a field of view shown by boundary lines (206a) and (206b). The radiation emitting device (203) has a radiation emitter (207) that can emit a radiation beam (204).

In this example, an internal mode of particle detection, using the internal detector of device (202) analyses an air sample representing a portion of the volume of air in the room (201). In the event that at least one of the particle detection criteria is met in this detection mode an alarm is triggered, and if appropriate a further detection mode is activated.

An external mode of particle detection is operable using the radiation emitting unit (203) to emit a radiation beam (204) from the radiation emitter (207). A portion of the radiation beam (204) falls within the field of view (206a) and (206b) of the camera (205). The camera (205) is integral with the device (202). The camera (205) captures images of the radiation beam (204). In this example, these images are analysed for forward and/or back scattered radiation. This scattered radiation provides positional information of the particles in the volume of air. On detection of particles by the external mode of particle detection, an alarm is triggered, and if appropriate a further detection mode is activated.

As with the system of FIG. 1, the system of FIG. 2 can be operated such that: (i) the first detection mode is an internal detection mode, and the second detection mode is an external detection mode; or (ii) the first detection mode is an external detection mode, and the second detection mode is an internal detection mode. Furthermore, the system may include a third detection mode as previously described.

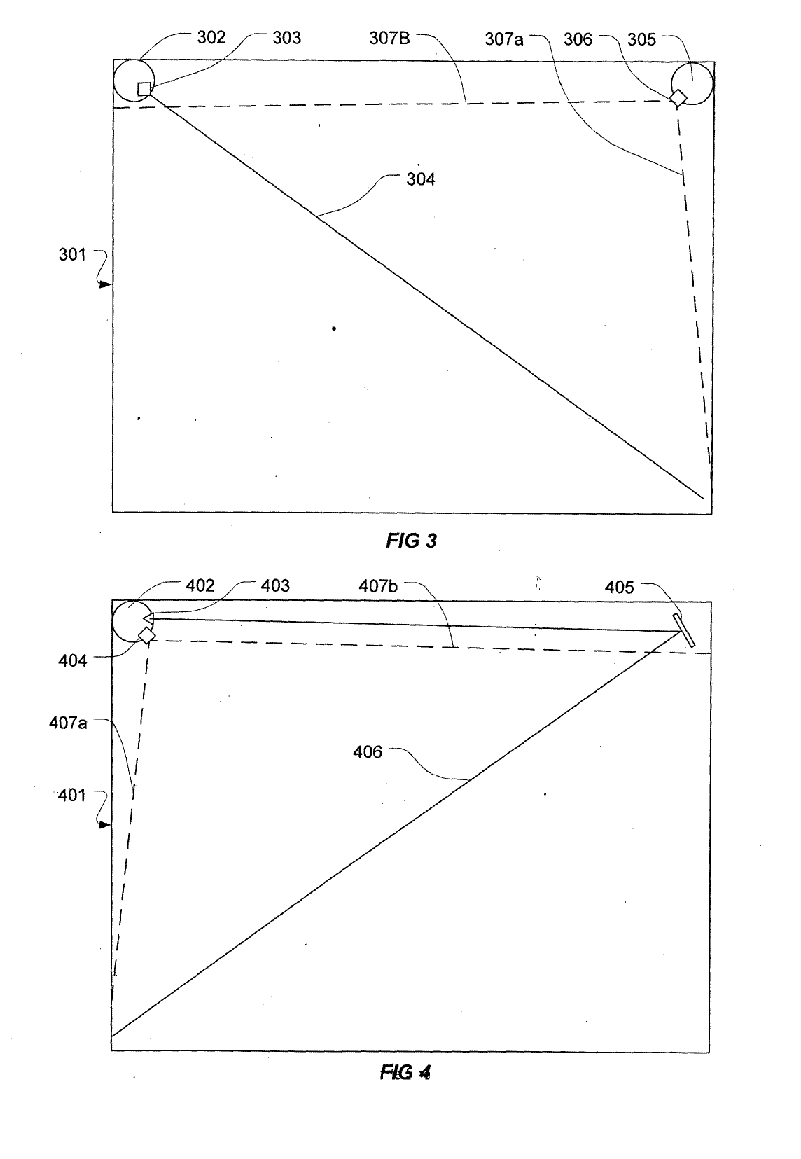

FIG. 3 provides an illustrative example of a multi-mode particle detection system including a type-1 device (302) and a type-2 device (305). A room (301) is fitted with two multi-mode particle detection devices, a first particle detection device (302) and a second particle detection device (305). The first particle detection device (302) includes an internal particle detector (not shown) and a radiation emitter (303). The radiation emitter can emit a radiation beam (304). The second particle detection device (305) includes an internal particle detector (not shown) and a sensor (306), which in this embodiment is a camera. The camera has a field of view shown by boundary lines (307a) and (307b).

In this example, a first mode of particle detection operates using the internal detectors of the first particle detection device (302) and the second particle detection device (305). These internal detectors analyse an air sample representing a portion of the volume of air in the room (301). In the event that at least one of the particle detection criteria is met in the first detection mode by either of the first particle detection device (302) or the second particle detection device (305), a first alarm is triggered, and the second detection mode is activated. In this mode, the first detection device (302) emits a radiation beam (304) from a radiation emitter (303) that is integral with the device (302). The second detection device (305) includes a sensor (306), which in this case is a camera with a field of view defined by (307a) and (307b). The camera (306) is integral with the second detection device (305). A portion of the radiation beam (304) falls within the field of view (307a) and (307b) of the camera (306). The camera (306) captures images of the radiation beam (304). In this example, these images are analysed for forward and/or back scattered radiation. This scattered radiation provides positional information of the particles in the volume of air.

As per previously, the system of FIG. 3 can be operated such that: (i) the first detection mode is an internal detection mode, and the second detection mode is an external detection mode; or (ii) the first detection mode is an external detection mode, and the second detection mode is an internal detection mode. Furthermore, the system may include a third detection mode as previously described.

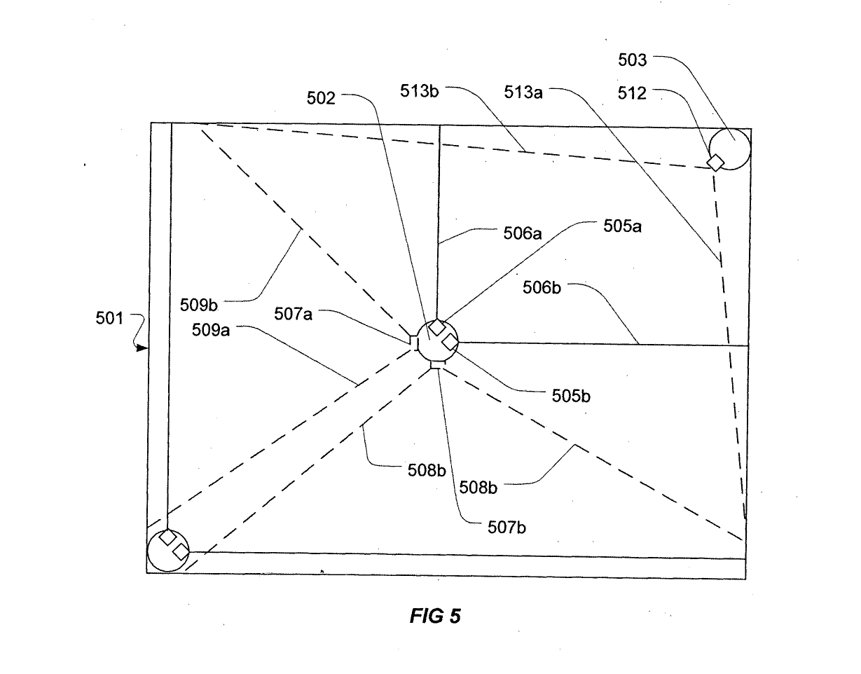

FIG. 4 provides an illustrative example of a multi-mode particle detection system including a type-3 device (402) and a reflector (405). A room (401) is fitted with a multi-mode particle detection device (402). The device (402) includes an internal particle detector (not shown), a radiation emitter (403), and a sensor (404), which in this particular embodiment is a camera. Both the emitter (403) and the camera (404) are integral with the device (402). The camera (404) has a field of view shown by boundary lines (407a) and (407b). The room (401) also includes a reflector (405). The radiation emitter (403) emits a radiation beam (406) which reflects off the mirror and through the field of view (407a) and (407b) of the camera (404).

In this example, an internal mode of particle detection uses the internal detector of device (402) to analyse an air sample representing a portion of the volume of air in the room (401). In the event that at least one of the particle detection criteria is met in the internal detection mode an alarm is triggered, the triggering of the alarm may activate additional detection modes (for example, if this is the first detection mode, on detection of particles, a second detection mode is triggered).

The particle detection system also includes an external mode of particle detection. The device (402) emits a radiation beam (406) from a radiation emitter (403) that is integral with the device (402). The device (402) also includes a sensor (404), which in this case is a camera with a field of view defined by (407a) and (407b). The camera (404) is integral with device (402). The radiation beam (406) projects through the room (401) and is reflected using a reflector (405) through the field of view (407a) and (407b) of the camera (404). The camera (404) captures images of the radiation beam (406). In this example, these images are analysed for forward and/or back scattered radiation. This scattered radiation provides positional information of the particles in the volume of air. If particles are detected, an alarm is triggered; the triggering of the alarm may activate additional detection modes (as previously described).

As with the previous examples, it is generally understood that either of the internal or the external modes of particle detection may be the first or second modes. It is also generally understood that additional modes of particle detection, such as video verification may also be employed.

FIG. 5 provides an illustrative example a particle detection system including: three multi-mode detectors, a modified type-1 device (504), a type-2 device (503), and a modified type-3 device (502). A room (501) is fitted with three multi-mode particle detection devices, a first particle detection device (502), a second particle detection device (503), and a third particle detection device (504). The first particle detection device (502) includes an internal particle detector (not shown), a number of radiation emitters (505a) and (505b), and a number of sensors (507a) and (507b), which in this embodiment are cameras. Each of the radiation emitted emits a radiation beam (506a) and (506b) respectively. Each of the cameras has a field of view denoted by dotted lines (508a) and (508b), and (509a) and (509b) respectively. The second particle detection device (504) includes an internal particle detector (not shown) and a number of radiation emitters (510a) and (510b). Each radiation emitter emits a radiation beam denoted by lines (511a) and (511b) respectively. A third particle detection device (503) is also included in the system. The third particle detection device includes an internal particle detector (not shown) and a sensor (512), which in this embodiment is a camera. The camera (512) has a field of view denoted by (513a) and (513b). In this example, radiation beams (506a) and (506b) pass through the field of view of camera (512), radiation beam (511a) passes through the field of view of camera (507b), and radiation beam (511b) passes through the field of view of camera (507a).

In this example, an internal mode of particle detection uses the internal detectors of the first particle detection device (502), the second particle detection device (503), and the third particle detection device (504), to analyse an air sample representing a portion of the volume of air in the room (501). In the event that at least one of the particle detection criteria is met in the by either of the first particle detection device (502), the second particle detection device (503), or the third particle detection device (504), an alarm is triggered and a further particle detection mode may be activated.

In the external detection mode, the first detection device (502) emits radiation beams (506a) and (506b) from radiation emitters (505a) and (505b) respectively, these emitters are integral with the first device (502). Furthermore, in this mode, the third detection device (504) emits radiation beams (511a) and (511b) from radiation emitters (510a) and (510b) respectively, these emitters are integral with the third device (504). The first detection device (502) includes sensors (507a) and (507b), which in this case are cameras with a field of view defined by (508a) and (508b), as well as (509a) and (509b). The cameras (507a) and (507b) are integral with the first detection device (502). A portion of the radiation beam (511a) falls within the field of view of camera (507b). A portion of the radiation beam (511b) falls within the field of view of camera (507a). The cameras capture images of the respective radiation beams. The second detection device (503) includes a sensor (512), which in this case is a camera with a field of view defined by (513a) and (513b). The camera (512) is integral with the second detection device (503). A portion of radiation beams (506a) and (506b) fall within the field of view of camera (512). The camera captures images of each of radiation beams (506a) and (506b). In this example, these images are analysed for forward and/or back scattered radiation. This scattered radiation provides positional information of the particles in the volume of air. If particles are detected, an alarm is triggered; the triggering of the alarm may activate additional detection modes (as previously described).

In the foregoing embodiments, the illustrative examples of the external mode of particle detection use a static, linear or collimated beam. The present invention should not be considered to be limited to in this way. Embodiments of the present invention can a source that generates a radiation beam having a more complex shape, such as 2D sheet, cylinder or other spatial pattern rather than a pencil-like beam. One implementation of such a detection mode is described in US 2011/0058167 in connection with FIGS. 42, 43 and 45. In other examples a laser bean can be transmitted through a hologram to generate a sheet or pattern or sweep the laser quickly to generate a sheet while the camera shutter is open. Other techniques are also possible.

As with the previous examples, it is generally understood that either of the internal or the external modes of particle detection may be the first or second modes. It is also generally understood that additional modes of particle detection, such as video verification may also be employed.

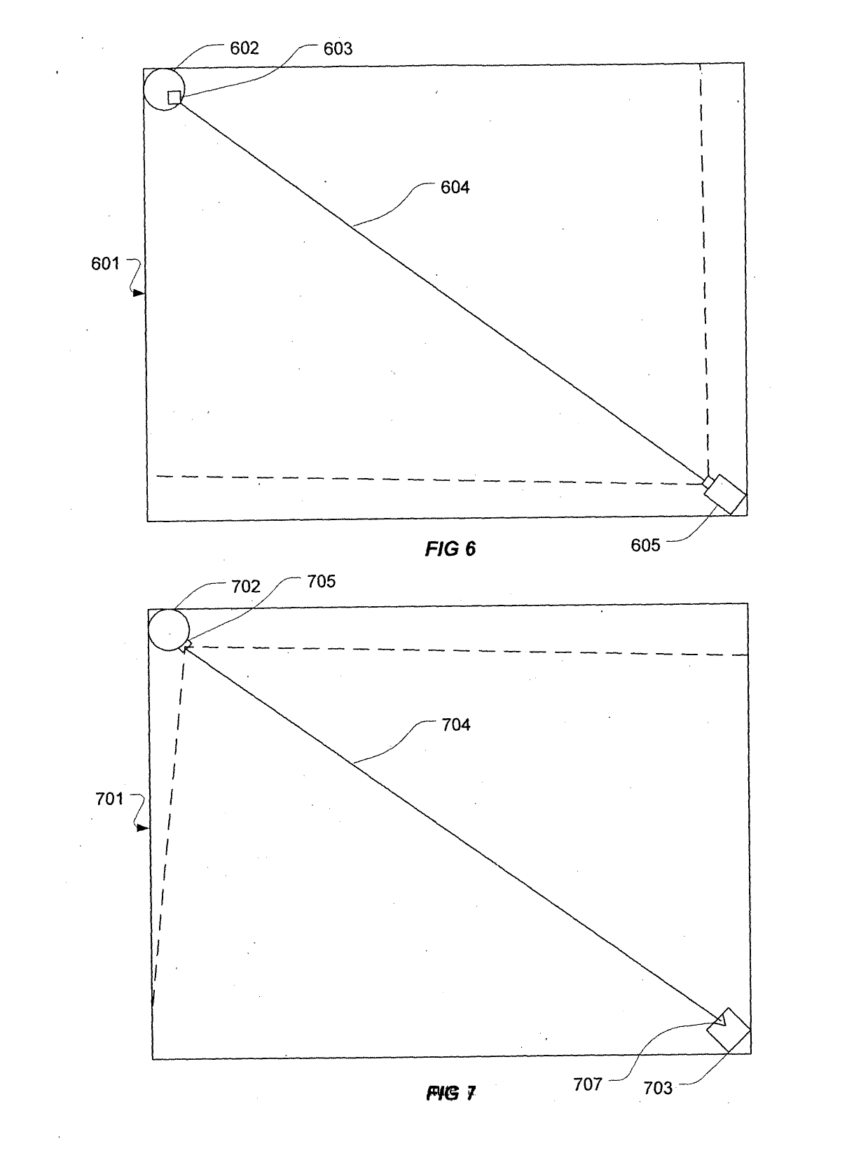

FIGS. 6 and 7 provide a similar arrangement to that shown in FIGS. 1 and 2 respectively. Except in these Figures, the method of external particle detection is through measuring attenuation of the laser beam.

Specifically, FIG. 6 provides an example of a room (601) containing a particle detecting system that includes a type-1 device (602), and a sensor (605). The particle detection device (602) has an internal sensor for detecting particles (not shown) and a radiation emitter (603) that is integral with the device. The sensor (605) may be light detecting sensor such as a camera or a photodiode; however, in this case the sensor is a camera.

An internal particle detection mode uses the internal sensor of the device (602). An external particle detection mode uses the combination of the light emitter (603) of the device (602) with the camera (605). The light emitter (603) projects a radiation beam (604) through a volume of air. The camera (605) measures the intensity of the received beam (604). The presence of particles will diminish the intensity of the beam, indicating the presence of particles.

FIG. 7 provides an alternative arrangement to that shown in FIG. 6, which operates in much the same manner. Essentially, FIG. 7 provides an example of a room (701) containing a particle detecting system that includes a type-2 device (702), and a radiation emitter (703). The particle detection device (702) has an internal sensor for detecting particles (not shown) and a camera (705) that is integral with the device.

The present inventors have also identified that using either a type 2 device such as that illustrated in FIG. 8B, or another imaging device, such as a security camera or dedicated image capture system, verification of alerts and other smoke and/re detection processes can be provided in order to minimise false alarm situations. In this regard, in a first mode of operation, a particle detection system such as that described herein or any conventional particle detection system can be used to perform an initial particle detection process. Upon detection of particles at a first threshold level, say a pre-alarm level a video verification process can be commenced. The video verification process can involve performing analysis of a plurality of images of the volume being monitored in order to determine the presence of either smoke or fire in the captured images. A range of video analytics techniques are known to be used for determining the presence of either smoke or file in images and as such this will not be described here in detail. Such video analytics techniques typically involve analysis of the image to detect features within the image which have visual characteristics commensurate with either smoke or fire and/or determining an extent of the smoke and/or fire within the image.

In some embodiments, video images of a scene can be captured continuously, and preferably video analysis also run continuously. In such a system, upon detection of particles at a first threshold level, say a pre-alarm level, the current, or subsequent status of the video analysis is used. This has the advantage that the video analysis system has access to video images and other data that were captured prior to the detection of particles, which can aid in its performance.

The other advantage of continuous video capture and analysis is that the video analysis may run continuously, and may detect particles prior to any type-1, type-2, or type-3 devices. In this instance the video analytics can be configured to trigger an alarm. If a type-1, type-2, or type-3 device subsequently detects particles, then the status of the alarm can be changed to a verified alarm, as described elsewhere herein, or considered as being verified immediately upon detection.

In more sophisticated embodiments, a combination of one or more channels of video analysis detection and one or more type-1, type-2 or type-3 detectors may operate in a double-knock fashion. In this instance, two or more detectors must have detected particles within a user definable timeframe in order to trigger an alarm. Preferably the two (or more) detectors that detected particles within a the defined timeframe are monitoring the same volume of air, but in some instances they may monitor related locations. In these examples, the video analysis system may run continuously, or it may commence image capture or analysis, when one or more of the type-1, type-2, or type-3 detectors detects particles.

In the event that an alert condition which is detected by the primary particle detection system is verified by the video verification system an alert level assigned to the particle detection output can be raised, or an indication given to a user of the system that the detected event has been verified. Moreover, images of the volume of air can be presented to a user of the system to aid human verification. These images can be presented in a manner that includes an indication of where, in an image, smoke and/or fire is determined to be present by the video verification system as an aid to make manual verification faster.

In an alternative mode of operation, the video analysis process can be run continually (or for determined period as needed) and in the event that captured images are determined to include an image of smoke and/or fire, the operation of other smoke or fire sensing systems can be triggered or altered. For example, sensitivity of the sensors can be increased e.g. by decreasing the threshold sensing levels or alarm delay times such that early detection is prioritised.

FIG. 9 is a floor plan of a building 900 including plurality of rooms. Each of the rooms is indicated as belonging to a zone which is monitored by a respective camera. In this regard, zone 1 is monitored by camera 901; zone 2 by camera 902; zone 3 by camera 903; zone 4 by camera 904; zone 5 by camera 905; zone 6 by camera 906; zone 7 by camera 907; and zone n by camera 908.

Each of the zones also includes a particle detector 910.1 to 910.n. The particle detectors 910.1 to 910.n could be of any type including point detectors, aspirated detectors, beam detectors, open area active video detectors as mentioned above or detectors made in accordance with types 1, type 2 or type 3 described elsewhere herein. The particle detectors 910.1 through 910.n are each connected to a building smoke alarm system either in the form of an FACP or central controller 912, and may be individually identified as having an address on that system to enable the location of fire detection within the building 900 to be determined by the fire alarm system. The location of the smoke detection within the fire alarm system can be determined in any fashion, for example using any one of the techniques described in any of Australian patent applications 2012904516, 2012904854 and 2013200353 filed by the applicant. These techniques are particularly adapted for use in aspirated particle detection systems. For point detectors the location of diction is easily determined. Each of the cameras 901 to 908 are connected to a central control system 912. The central control system 912 is a video analytics system which receives and analyses video feeds from the multiple cameras. The central controller can also store and transmit video feeds to a central monitoring station either in real time or on demand as events are detected. The controller 912 is connected via a communications channel to a central monitoring station (CMS) 914, at which alarm situations, both fire related and security related, can be monitored. In alternative embodiments the functions of the controller 912 and FACP can be combined into a single device. Also the functions of the central monitoring station 914 could be performed at the controller 912. Similarly the cameras other security systems (not shown) and fire and/or smoke can connect directly to a remote CMS which performs all monitoring and analysis (i.e. the functions of the controller 912 and FACP) directly.

Consider now a situation in which a fire starts in zone 2 of the building 900 of FIG. 9. In this case, the sensor system 910.2 located within the room will detect the presence of smoke particles in plume 911 and send an alert signal to the fire alarm control panel (FACP). As is conventional in such systems the output signal of the sensor 910.2 can indicate a level of particles detected or an alarm state determined according to alarm logic of the detector. The fire alarm control panel will communicate this alert data via central controller 912 back to the central monitoring station 914 where staff can monitor conditions in the building 90. Because the system includes video verification capabilities, upon detection of particles in zone 2 by detector 910.2, video verification using camera 902 is activated. The camera 902 begins either capturing (if it was not previously capturing images) images or analysing images to determine whether smoke can be verified to be present from the images. The video feed from the camera 902 is provided to the central controller 912. The central controller 912 performs video analytics on a series of frames captured by camera 902 to determine if there are visual features in the images which indicate either the presence of smoke or flame within the field of view 902.1 of the camera 902. This video analytics can be performed either in the controller 912 or at the central monitoring station 914. If the analysis is to be performed at the central monitoring station 914 the video images, perhaps in a compressed form, will need to be transmitted from the site controller 912 to the central monitoring station 914 for analysis. Upon detection of smoke or fire in the images captured by camera 902 the alert system running at the central monitoring station 914, can modify its output to indicate that the alert condition indicated by the smoke detector 910.2 is verified by the video analytics system. From this verification a user can infer that the chance of a false alarm is low.

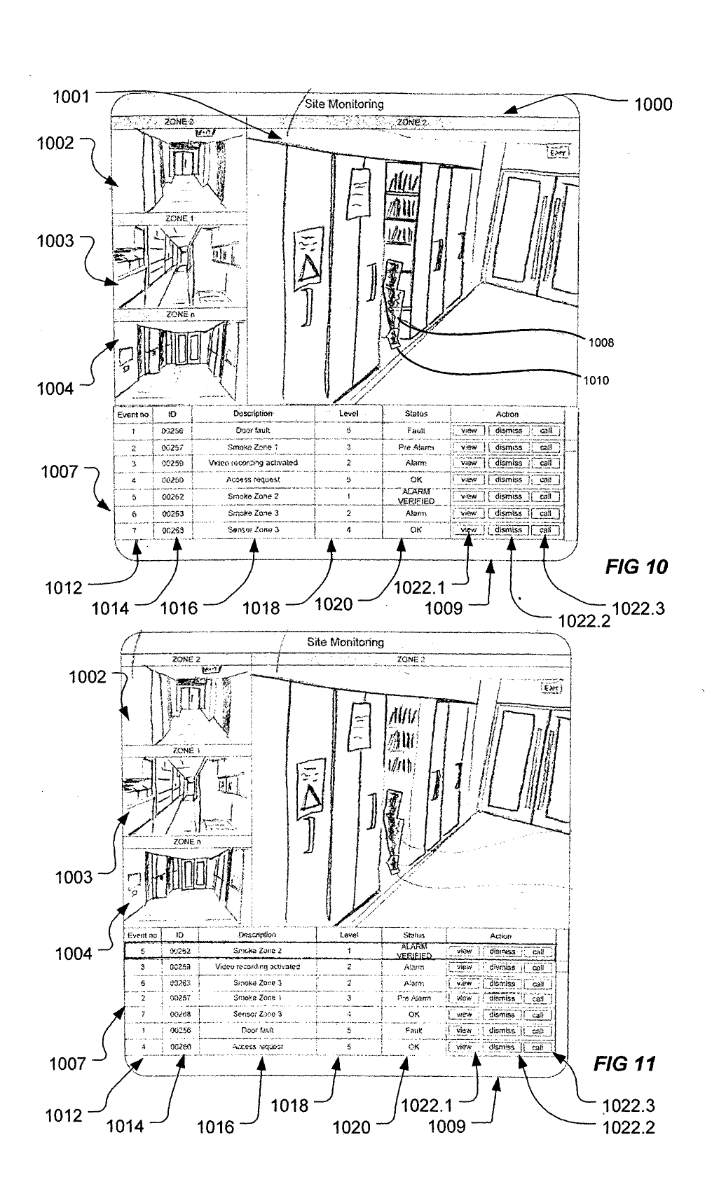

By indicating to the user monitoring the central monitoring station 914 that a fire or smoke alarm has been verified, the importance level of that alarm will be raised. Accordingly the person monitoring the system will be encouraged to act more quickly on the alert. FIGS. 10 and 11 show two alternative interfaces which can be provided for the central monitoring station according to embodiments of the present invention. Turning firstly to FIG. 10, the interface includes a plurality of video display panes 1001, 1002, 1003 and 1004 each of which displays images captured from different cameras within the building 900 which is being monitored. The large viewing pane 1001 is provided in order to give a closer view of a location to the user of the monitoring system such that they can visually inspect a scene at which an alert has occurred. The smaller display panes 1002 through 1004 may cycle according to an appropriate scheme or alternatively be ranked in a priority order according to alert levels in the corresponding zones. The bottom portion of the interface 1000 includes a list of events 1007. For each event, event data is displayed and the user of the system is provided with a series 1009 of buttons for performing certain response actions. For each event the following data is displayed: an event number 1012 being a numerical listing of events, an “Event ID 1014 being a system-wide unique identifier for the event used for indexing logged event data for access at a later time; an event description 1016 explaining the nature of the event; an event level 1018 being a priority ranking for the event; an indicator of the status 1020 of the event e.g. whether it is an alarm or fault or other particular type of alert a series of action buttons 1022.1, 1022.2, 1022.3.

Event number 5 in the present example, has the highest alert status and will be described herein in more detail. Event number 5 is an indication that smoke has been detected in zone 2. The smoke in this example has been detected by particle detector 910.2 at a level indicating that alarm should be raised. In the status column, the event is indicated as “alarm verified” because the video analytic system has analysed the output of camera 902 and determined that smoke and fire is present. In order to indicate the verification to the user of the system, the interface has highlighted the status box corresponding to event number 5 and indicated in text form that the alarm is “verified”. As will additionally be noted the image of zone 2 includes a visual indicator 1008 of the location of the smoke and fire detected by video analytics system. In this regard, the video analytic system has performed an analysis of a series of images captured by camera 902 and has indicated a boundary or edge around a region within the image which is determined to represent smoke. Additionally, an indication of a zone within the image 1010 is indicated as appearing to represent flame which is causing the fire.

FIG. 11 shows an alternative interface to that of FIG. 10 the only difference between the interfaces of the two figures is that rather than simply indicating that the status of event number 5 has been “verified” the interface of FIG. 11 orders each of the events in the event list according to their alarm level and verification level. This additionally highlights that greater priority should be given to event number 5 compared to the other events within the system.

Once an event has been detected and verified by the automatic video verification system it will be up to a human user of the system to determine an action to be performed in response to the event. The person may choose to dismiss the event (1022.2) or view the video feed (button 1022.1) corresponding to the event to further investigate or to raise an external alarm (1022.3) by either calling Police, fire brigade or other appropriate emergency response services. This can be performed using the interfaces of FIGS. 10 and 11 using the buttons view (1022.1), dismiss (1022.2) or call (1022.3) as indicated.

In an additional embodiment of the present invention, it is advantageous that the video analytic system further assists the user in their investigation of pending events. In this regard, a user of the system may wish to investigate the cause of an alert, for example by determining where the event has originated, or what the true cause of an event is, for example what or thing is on fire or in danger of being set alight and is causing a smoke detection event. Such information can be particularly valuable in determining a response strategy to an alert condition. For example, if it is known exactly what is on fire an appropriate suppression strategy can be implemented. Moreover, anything surrounding the fire can be visually inspected to determine what level of response is needed. For example, if important equipment or hazardous or flammable items surround the area above the fire is, a faster response may be needed or total evacuation whereas if a fire is detected in a relatively open area or area in which non-flammable items are located a slower (or at least different) response may be acceptable.

In order to assist in the investigation process, the central monitoring station can be provided with software which analyses alarm outputs from one or more cameras and condition sensors and makes a recommendation to a user as to the order of recommended investigation as to the source or nature of the event. For example, the software system can store a map or other geographical data as to the relative position of rooms and items in the premises being monitored, and using data representing which detectors have sensed an alert condition, determine either a likely central point at which the fire has originated or an investigation priority. For example, in FIGS. 10 and 11 a verified alarm has been sensed in zone 2 and an unverified alarm has been sensed in zone 3. A pre-alarm has also been sensed in zone 1. In a situation in which verification of the presence of flame (indicated at 1010 in FIG. 10) is not possible, the central monitoring station will recommend an order of manual analysis of other zones in order of zone 2, then zone 3, followed by zone 1, followed by zone N. This is based on received alert levels of zones 2, 3 and 1 and the proximity of the doorways of zones 2, 3, N and 7, and the fact that zone 1 is a corridor between them. In other embodiments other factors can also play a role in determining investigation order, e.g. if the building's air conditioning return duct is located at position 920 the output of detector 9140.12 may be treated as lower priority than all “upstream” detectors as it will tend to indicate smoke more often than other detection points.

Thus should smoke be detected at in e.g. zone 2 and zone 1 at detector 910.22 then zone 2 is likely to be the source of the fire. Conversely if only detectors 910.11 and 910.12 detect smoke, but no other detectors are, then zone 1 is the likely source of the fire condition.

It is also useful to note that without the video verification process applied to event 5 in FIG. 10 the alarm level of zones 2 and 3 would be otherwise identical. Without video verification there will be no additional information on which to base a decision that the fire is actually present in zone 2 and not zone 3 other than physical inspection. This clearly aids with the response strategy which because of the video verification process described herein enables a response to be targeted on zone 2 first which is where the fire is actually present.

The sensors (e.g. cameras) described in the illustrated may be fixed cameras or be capable of changing their field of view, e.g. be pan-tilt-zoom (PTZ) cameras. If a PTZ camera is used the camera can be programmed to pan, tilt, and zoom either to isolate locations that are identified as potentially causing an alert condition to enable investigation, Alternatively or additionally the PTZ camera can be controlled such that is captures images of a first view, and then moves to a second view and possibly one or more additional views successively, pausing for a specified time at each view. The sequence can be repeated indefinitely.

Video analysis can be performed on each view independently of the other views. In general terms this can be considered a process of performing time division multiplexing of images taken with the one camera at different PTZ settings, with each PTZ setting corresponding to a time slot. The video analytics can be performed on a series of images from successive instances of each PTZ time slot. Images captured in corresponding PTZ time slots can be treated as a “camera” and video analytics can be performed using the techniques described in earlier examples for a single camera.

Prior to use a the systems described herein will need to be commissioned, in that it is necessary to correlate the location of the air sampling inlets with their physical locations and also with the views of the cameras of the security system. In some cases it might even be desirable to correlate PTZ parameters of a particular cameras with a sampling point.

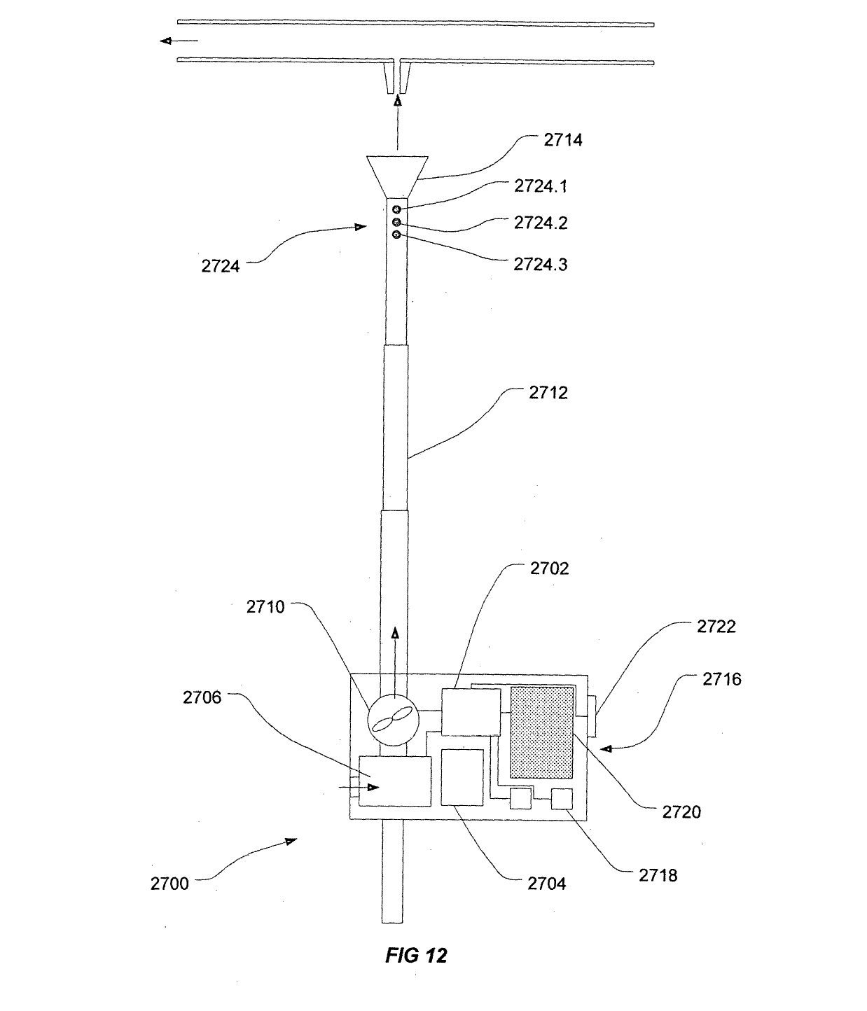

An apparatus and method for correlating an address in a particle detection system, said address corresponding to a physical location, with a location being monitored in a video capture system that monitors a plurality of locations will now be described in connection with FIG. 12. FIG. 12 illustrates an exemplary apparatus 2700 that can be used for conveniently commissioning, calibrating and/or testing particle detection systems. It could also be used in non-video enabled particle detection systems such as conventional Aspirating particle detections systems, as will be apparent from the following description.

The apparatus is arranged to provide a mechanism to perform smoke tests such that the location of the smoke can be learned by the smoke detector system and, in the case of a system with video verification of alerts, the security system also in a simultaneous fashion. The apparatus enables the operator to inject smoke (or other test particle) at each sampling inlet of an air sampling particle detection system, point detector or other smoke sensing device, preferably in no particular sequence, and record e.g. on an integral computer device such as tablet computer or the like, the physical location of the inlet or sensing device. The data can be transferred to the particle detector either in real time or afterwards, so that the particle detector knows which inlet is mapped to which physical location. Preferably (but not essentially) the apparatus enables the security system to identify which particular camera (and optionally PTZ parameters) is associated with each inlet's address location. Association of the inlet or sensor location with a location in the video security may be achieved by visible means. As the smoke injection occurs, the visual indicator is activated, e.g. by flashing a code for a time. The security system searches for the visual indicator and identifies images of it amongst the images captured by its various cameras. The security system can then correlate the right camera and optionally PTZ position with location of the air sampling inlet or sensor. Thus the apparatus 2700 according to the preferred embodiment includes:

a mechanism for delivering (and preferably generating) smoke to the a sampling inlet;

means for enabling detection of the apparatus in an image captured by the video security system, and optionally means to communicate data over this optical means.

means for synchronising the actions of the apparatus with the particle detection system and/or security system.

More particularly the exemplary device 2700 includes:

A controller 2702 that controls operation of the device apparatus 2700.

A power supply 2704, which will typically be a battery.

A smoke generator 2706 to produce test smoke for introduction to the sampling points as needed.

A fan 2710 to push the smoke to the point of delivery.

A duct 2712 to guide the smoke generated by the smoke generator 2706 to the point of delivery. In this example the duct 2712 is an extendible, e.g. telescopic, pipe to enable convenient use with sampling points at different heights and convenient device storage. The duct 2712 terminates in an exit port 2714 that is shaped to enable easy coupling to or around a sampling point. In this example the exit port 2714 is a funnel shaped exit port, that can fit over or around a sampling point.

A user interface 2716, which in this case includes one or more control buttons 2718 and a touch screen display 2720. These can be configured, in a manner know to those skilled in the art to control operation of the apparatus 2700 and enter data as will be described below.

A synchronisation port 2722, which can be a wired or wireless communications means for establishing data communications with external devices, e.g. the smoke detection system, video security system or elements of these systems. In the case that the port 2722 is wireless, the port 2722 can be used for real-time communications. If the port 2722 is adapted for making a physical connection, communications could be made in real time (e.g. my being plugged into the other systems during use) or asynchronously (e.g. sharing stored data and/or synchronisation of the device with one or both of the smoke detection system and video security systems after use).

A visual communications system 2724, which in this case includes an arrangement of radiation emitters 2724.1, 2724.2, 2724.3. The visual communications system can be used to communicate with the security system during use of the apparatus 2700, in a manner described below. The visual communications system 2724 may emit visible or invisible radiation, so long as it can be received and relayed to the video surveillance system. Most preferably the radiation is received by the security system and captured in its video images of a region. In this way, the presence of the apparatus 2700 and (optionally data) is conveyed by the state of the visual communications system 2724.

An exemplary use of the test apparatus 2700 will now be described in connection with commissioning a particle detection system that has a video verification performed by a video security system. The objective of the apparatus 2700 is to assist and preferably automate the configuration and verification of the integration between smoke detection system and video security system. Specifically, the tool aids the smoke detection system and video security system to have the same sense of physical locations that is being protected.

Prior to the start of the training process, the particle detector system and video security system is set to a “training” mode.

At each sampling inlet of the particle detector system smoke is generated by the technician using the apparatus 2700. When triggered, the apparatus 2700 generates an amount of smoke sufficient to trigger the particle detection system to detect particles. The trigger to generate smoke will also switch on a visual indicator that is distinguishable from background entities in the images captured by the security system. While in the “straining” mode the video security system analyses the imaged captured by it, and searches (either periodically or continuously) for the visual indicator 2724 in the images. Once found, it will record the apparatus's location (camera and PTZ presets if necessary) to identify which video camera will have the area surrounding the sampling hole in its field of view.

At the point of generating the smoke, the technician also records a name (and optionally a description) of the physical space e.g. using a keyboard interface on the touch screen display 2720. This text is stored along with the smoke test start and end time, and is optionally transmitted to the smoke detector and/or security system for correlating with detected events in these systems. During normal operation the text entered at this point can be presented to the CMS operator when the sampling hole is identified during actual use of the system.

The apparatus 2700 is configured e.g. programmed to guide the technician as to what action to take next, e.g. when move to a new sampling point, whether the technician needs to wait before triggering the smoke, the period that the technician needs to dwell with the smoke generator at the current hole, prompt for technician for name of the sampling hole etc.

Sampling points are typically located near the ceiling though there will be exceptions. The generated smoke needs to reach the sampling hole quickly and directly. However, it is strongly desirable that the technician always remain on the ground even when they trigger smoke to be presented in close proximity to a sample hole mounted high up in the ceiling, thus all controls are located at the bottom of duct 2712, and the duct 2712 is extensible.

The smoke generation start and end events for each sampling hole is synchronised with the particle detection system and video security system. This synchronisation can be done in real time over a wireless network. Optionally or alternatively the apparatus 2700 can provide the same capability without the real time use of wireless networks in an offline mode. For this later case, at the completion of the commissioning process the apparatus 2700 will need to be connected with the particle detection system and video security system to synchronise the recorded data including the name of the physical spaces. This could be performed via any communications medium or channel, including but not limited to, USB, Ethernet or WiFi.

In the example of FIG. 24 the following series of data are generated in the “training” mode by the test apparatus, smoke detection system and security system respectively.

TABLE 1
Test Apparatus data table

| Start time | End time | Physical location name | Co-ordinate (optional) |
|---|---|---|---|
| 1:00 | 1:01 | Main Corridor | −37.813621 |
| | | | 144.961389 |
| 1:05 | 1:06 | Boardroom | −37.813637 |
| | | | 144.961398 |
| 1:08 | 1.09 | Library | −37.813624 |
| | | | 144.961398 |
| . . . | . . . | . . . | . . . |
| 1:30 | 1:31 | Cleaner's Cupboard | −37.813610 |
| | | | 144.961372 |

TABLE 2
Smoke Detector table

| Start | End | Location parameter | Inlet number |
|---|---|---|---|
| 1:00 | 1:01 | 130 Litres | 5 |
| 1:05 | 1:06 | 125 Litres | 4 |
| 1:08 | 1.09 | 100 Litres | 2 |
| . . . | . . . | . . . | . . . |
| 1:30 | 1:31 | 16 Litres | 1 |

TABLE 3
Security System table

| Start | End | Camera | PT2 |
|---|---|---|---|
| 1:00 | 1:01 | 2401 | P = 5 |
| | | | T = 20 |
| | | | Z = 200 mm |
| 1:05 | 1:06 | 2403 | — |
| 1:08 | 1.09 | 3402 | — |
| . . . | . . . | . . . | . . . |
| 1:30 | 1:31 | 2405 | — |

Once the training data has been recorded by the test apparatus 2700, smoke detector system and security system, this data needs to be correlated in order for the video verification system and smoke detection systems to work together in the event of an actual smoke detection event. As can be seen the start and end times in each table can be used to correlate smoke test data with the smoke detector data and security system data.

In use, in the event that smoke is detected by the smoke detection system it will determine where in its system smoke was detected. If the system includes one or more point detectors “addressing” i.e. determining where the event was detected is relatively straightforward and only requires knowledge of which detector has detected smoke. If the system includes or is an aspirated particle detection system with an air sampling network the system can performs one of the localisation methods in any one of the following Australian patent applications 2012904516, 2012904854 or 2013200353 filed by the applicant or other localisation technique to identify the location of the source of the particles. The output could be a location, name (e.g. the name given by the technician during commissioning) room address or a smoke localization parameter (such as a volume of air sample that has passed through the detector between detection events whilst in the localisation phase, which identifies which of the sampling holes the smoke entered the smoke detection system through, as described in Australian patent applications 2012904516, 2012904854 or 2013200353). This output is passed to the security system. On the basis of this name, identifier or localization parameter the security system is able to determine which of its cameras provide a view of the determined air sampling point.

In this case, the security system will identify camera 2405 as the camera which will show a view of the region in which the smoke detection event has taken place.

As will be appreciated, additional information could be gathered during commissioning to aid the CMS operator in determining an appropriate action when smoke or a fire is detected.

Additional features can also be included in some embodiments of the apparatus 2700. For example, in some embodiments other methods can be used to determine the location of the apparatus 2700 to assist or automate identification of the location and sampling inlet. For example satellite positioning (e.g. GPS or DGPS) or triangulation from electromagnetic emitters, could be used to determine which room the apparatus is in, thereby obviating or minimising the need to enter data into the system. The sampling point may be provided with a short range communications mechanism, e.g. an RFID tag, that is read by a reader mounted near the end of the duct 2712 to identify which sampling point is being commissioned in each step. This communication could also be used as the trigger for beginning the test procedure for the sampling point.

As can be seen from the foregoing embodiments, by combining video analytics techniques with conventional particle detection systems or multimode particle detection systems described herein an increased level of certainty and decreased false alarm rate can be obtained. Moreover, additional data about the source and spread of smoke and fire can be obtained using such a hybrid system.

As with all of, the examples, either the internal detection mode, or the external detection mode may be the first detection mode, with the other of the internal detection mode or the external detection mode being the second detection mode. An additional third detection mode, such as video verification, may be employed.

It will be understood that the invention disclosed and defined in this specification extends to all alternative combinations of two or more of the individual features mentioned or evident from the text or drawings. All of these different combinations constitute various alternative aspects of the invention.

1-31. (canceled)

32. An alert system including:
at least one first input to receive a signal indicating a sensed condition from a sensor system that indicates the presence of smoke and/or fire;
at least one second input to receive a signal derived from a video capture system;
the alert system being configured to indicate a first alert condition based on the at least one first input; and to indicate a second alert condition in the event that the sensed condition is verified by the signal derived from the video capture system.

33. The alert system of claim 32, wherein the alert system receives a series of images captured by the video capture system on the second input and processes the images to determine whether smoke and/or fire is present in the series of images.

34. The alert system of claim 32, wherein the alert system receives a signal from the video capture system on the second input indicating that smoke and/or fire is present in images captured by the video capture system.

35. The alert system of claim 32 wherein the video images include a visual indication of the location, volume, shape or other parameter of the smoke and/or fire that is determined to be present in the images.

36. An interface for an alert system including an interface portion for indicating a plurality of alert conditions, including
alert conditions relating to fire and/or smoke detection, and
an interface element configured to indicate that an alert condition relating to fire and/or smoke detection has been verified.

37. The interface of claim 36 wherein the interface element is configured to indicate that an alert condition relating to fire and/or smoke detection has been verified on the basis of one or more images of a volume being monitored for fire or smoke.

38. The interface of claim 37 wherein the verification is automatically performed by analysing a series of images to determine that an image of smoke or fire is present in the captured images.

39. The interface of claim 36 wherein the interface element includes at least one of: an icon, indicia, colour selection, alphanumerical indicator, indicated status level; or a variation in display style or order; or a change or modulation of another interface element that conveys that the alert condition has been verified.

40. The interface of claim 36 wherein the interface includes a portion to display at least part of an image captured by the video capture system, to enable visual confirmation of the alert condition by an operator.

41. The interface of claim 40 wherein the at least part of the image displayed may include a visual indication of the location, volume, shape or other parameter of the smoke and/or fire that is determined to be present in the images.

42. A method including:
receiving smoke and/or fire detection data corresponding to a plurality of sensors arranged in respective locations;
receiving at least one image of the respective locations;
providing an interface for viewing the display of least one image of the respective locations according to a priority level determined on the basis of at least one of:
received smoke and/or fire detection data;
an analysis of at least one image of the respective locations;
location parameter data describing one or more characteristics pertaining to the locations.

43. The method of claim 42 including generating one or more alerts corresponding to the received smoke and/or fire detection data.

44. The method of claim 42 wherein the received smoke and/or fire detection data includes parameters such as the volume of the detected smoke and/or fire, and/or the rate of increase of the volume of smoke and/or fire.

45. The method of claim 42 including prioritising display of the one or more alerts corresponding to received smoke and/or fire detection data on the basis of the priority level.

46. The method of claim 42 wherein the priority level of an alert condition relating to fire and/or smoke detection can be determined at least in part on the basis of an automated measure of any one or more of:
size, intensity, density, growth;
for any one of:
fire, smoke cloud or particle-cloud.

47. The method of claim 42 including, for a given alert, indicating an investigation priority on the basis of, any one or more of:
received smoke and/or fire detection data;
an analysis of at least one image of the respective locations;
location parameter data describing one or more characteristics pertaining to the locations.

48. The method of claim 47 wherein the step of indicating an investigation priority includes ordering a sequence in which images of a series of locations are to be displayed; the investigation priority being determined to increase the likelihood that an origin of the cause of the alert will be discovered, by visual inspection of images of the locations.

49. The method of claim 42 wherein the location parameter data describes characteristics pertaining to the location, such as: a locations actual position, position relative to other locations, construction of rooms or other things in the location, wind or airflow speed, direction, patterns; location usage pattern, usage type, or HVAC system parameters.

50. A computing system programmed to perform at least part of the method according to claim 42.

51-69. (canceled)

70. The interface of claim 36 wherein the interface element is configured to indicate a priority of an alert condition relating to fire and/or smoke detection.
